(19) United States
(12) Patent Application Publication
(10) Pub. No.: US 2012/0214944 A1
(43) Pub. Date: Aug. 23, 2012

(54) POLYOLEFIN POLYLACTIC ACID IN-SITU BLENDS

(75) Inventors: FENGKUI LI, Houston, TX (US); John Ashbaugh, Houston, TX (US)

(73) Assignee: Fina Technology, Inc., Houston, TX (US)

(21) Appl. No.: 13/030,196

(22) Filed: Feb. 18, 2011

(51) Int. Cl. C08L 67/04; C08L 51/06; C08L 23/02

(52) U.S. Cl. 525/186

(57) ABSTRACT

Polymeric compositions and methods of forming the same are described herein. The methods generally include contacting a polyolefin and a lactide in the presence of a catalyst within an extruder under conditions sufficient to polymerize the lactide and form a polymeric composition including polyolefin and polylactic acid.

### FIELD

Embodiments of the present invention generally relate to polymeric blends.

### BACKGROUND

As reflected in the patent literature, synthetic polymeric materials, such as polypropylene and polyethylene resins, are widely used in the manufacturing of a variety of end-use articles ranging from medical devices to food containers. Many industries, such, as the packaging industry, utilize polypropylene materials in various manufacturing processes to create a variety of finished goods.

However, while articles constructed from synthetic polymeric materials have widespread utility, one drawback to their use is that these materials tend to remain semi-permanently in a natural environment. In response to environmental concerns, interest in the production and utility of more readily biodegradable polymeric materials has been increasing. These materials, also known as “green materials”, may undergo accelerated degradation in a natural environment. The utility of these biodegradable polymeric materials can be limited by poor mechanical and/or physical properties.

Therefore, a need exists for polymeric compositions including biodegradable components having desirable physical and/or mechanical properties.

### SUMMARY

Embodiments of the present invention include methods of forming a polymeric composition. The methods generally include contacting a polyolefin and a lactide in the presence of a catalyst within an extruder under conditions sufficient to polymerize the lactide and form a polymeric composition including polyolefin and polylactic acid.

One or more embodiments include the method of the preceding paragraph, wherein the polyolefin is selected from polyethylene, polypropylene and combinations thereof.

One or more embodiments include the method of any preceding paragraph, wherein the lactide is selected from D-lactide, L-lactide, or D,L-Lactide and combinations thereof.

One or more embodiments include the method of any preceding paragraph, wherein the catalyst is selected from octoate (tin(II)-di-2-ethyl hexanoate), tin octylate, tetraisopropyl titanate, zirconium isopropoxide, antimony trioxide and combinations thereof.

One or more embodiments include the method of any preceding paragraph, wherein the polymeric composition includes polyolefin in an amount of from about 51 wt. % to about 99 wt. % based on the total weight of the composition.

One or more embodiments include the method of any preceding paragraph, wherein the polymeric composition includes polylactic acid in an amount of from about 1 wt. % to about 49 wt. % based on the total weight of the composition.

One or more embodiments include the method of any preceding paragraph, wherein the catalyst contacts the polyolefin and lactide in an amount of from about 0.0.1 wt. % to about 2 wt. %.

One or more embodiments include the method of any preceding paragraph, wherein the catalyst contacts the polyolefin and lactide at a temperature of from about 180° C. to about 210° C.

One or more embodiments include the method of any preceding paragraph, wherein the catalyst contacts the polyolefin and lactide for a time of from about 5 minutes to about 3 hours.

One or more embodiments include the method of any preceding paragraph further including contacting the polymeric composition with a reactive modifier.

One or more embodiments include the method of any preceding paragraph, wherein the reactive modifier is selected from an epoxy-functionalized polyolefin, oxazoline-functionalized polyolefins, isocyanate-functionalized polyoefins, and polyolefin-based ionomers.

One or more embodiments include a polymeric composition formed by the method of any preceding paragraph.

One or more embodiments include the polymeric composition of the preceding paragraph further including a reactive modifier.

One or more embodiments include the polymeric composition of any preceding paragraph, wherein the reactive modifier includes an epoxy-functionalized polyolefin, oxazoline-functionalized polyolefins, isocyanate-functionalized polyoefins, and polyolefin-based ionomers.

One or more embodiments include the polymeric composition of any preceding paragraph, wherein the polyolefin is selected from polyethylene, polypropylene and combinations thereof.

One or more embodiments include the polymeric composition of any preceding paragraph, wherein the polymeric composition includes polyolefin in an amount of from about 51 wt. % to about 99 wt. % based on the total weight of the composition.

One or more embodiments include the polymeric composition of any preceding paragraph, wherein the polymeric composition includes polylactic acid in an amount of from about 1 wt. % to about 49 wt. % based on the total weight of the composition.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in, some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Embodiments described herein include blending a polyolefin and a lactide in the presence of a catalyst to form a polymeric blend. The polymeric blend may display desirable physical and/or mechanical properties or other characteristics, such as increased strength and/or improved optical properties when compared to either polyolefin or polylactic acid alone or their physical blends. Hereinafter, property comparisons (e.g., mechanical, physical, optical) are being made in comparison to a polymeric composition comprising an otherwise similar polyolefin composition lacking polylactic acid or an otherwise similar polylactic acid composition lacking polyolefin.

Furthermore, it is expected that the polymeric blends may exhibit improved dispersion over blends of polyolefins and polylactic acid.

In an embodiment, the polymeric blend includes polypropylene. The polypropylene may be a homopolymer provided however that the homopolymer may contain up to 5% of another alpha-olefin, including but not limited to C₂-C₈ alpha-olefins, such as ethylene and 1-butene. Despite the potential presence of small amounts of other alpha-olefins, the polypropylene is generally referred to as polypropylene herein.

In an embodiment, the polypropylene is present in the polymeric blend in an amount of from 51 weight percent (wt. %) to 99 wt. % by total weight of the polymeric blend, alternatively from 70 wt. % to 95 wt. %, alternatively from 80 wt. % to 90 wt. %.

In an embodiment, a polypropylene suitable for use in this disclosure may have any combination of the following properties. For example, the polypropylene may have a density of from 0.895 g/cc to 0.920 g/cc, alternatively from 0.900 g/cc to 0.915 g/cc, and alternatively from 0.905 g/cc to 0.915 g/cc as determined in accordance with ASTM D1505; a melting temperature of from 150° C. to 170° C., alternatively from 155° C. to 168° C., and alternatively froth 160° C. to 165° C. as determined by differential scanning calorimetry; a melt flow rate of from 0.5 g/10 min. to 30 g/10 min., alternatively from 1.0 g/10 min. to 15 g/10 min., and alternatively from 1.5 g/10 min. to 5.0 g/10 min. as determined in accordance with ASTM D1238 condition “L”; a tensile modulus of from 200,000 psi to 350,000 psi; alternatively from 220,000 psi to 320,000 psi, and alternatively from 250,000 psi to 320,000 psi as determined in accordance with ASTM D638; a tensile stress at yield of from 3,000 psi to 6,000 psi, alternatively from 3,500 psi to 5,500 psi, and alternatively from 4,000 psi to 5,500 psi as determined in accordance with ASTM D638; a tensile strain at yield of from 5% to 30%, alternatively from 5% to 20%, and alternatively from 5% to 15% as determined in accordance with ASTM D638; a flexural modulus of from 120,000 psi to 330,000 psi, alternatively from 190,000 psi to 310,000 psi, and alternatively of from 220,000 psi to 300,000 psi as determined in accordance with ASTM D790; a Gardner impact of from 3 in-lb to 50 in-lb, alternatively from 5 in-lb to 30 in-lb, and alternatively from 9 in-lb to 25 in-lb as determined in accordance with ASTM D2463; a Notched Izod Impact Strength of from 0.2 ft lb/in to 20 ft lb/in, alternatively from 0.5 ft lb/in to 15 ft lb/in, and alternatively from 0.5 ft lb/in to 10 ft lb/in as determined in accordance with ASTM D256A; a hardness shore D of from 30 to 90, alternatively from 50 to 85, and alternatively from 60 to 80 as determined in accordance with ASTM D2240; and/or a heat distortion temperature of from 50° C. to 125° C., alternatively from 80° C. to 115° C., and alternatively from 90° C. to 110° C. as determined in accordance with ASTM D648.

In another embodiment, the polypropylene may be a high crystallinity polypropylene homopolymer (HCPP). The HCPP may contain primarily isotactic polypropylene. The isotacticity in polymers may be measured via 13C NMR spectroscopy using meso pentads and can be expressed as percentage of meso pentads (% mmmm). As used herein, the term “meso pentads” refers to successive methyl groups located on the same side of the polymer chain. In an embodiment, the HCPP has, a meso pentads percentage of greater than 97%, or greater than 98%, or greater than 99%. The HCPP may comprise some amount of atactic or amorphous polymer. The atactic portion of the polymer is soluble in xylene, and is thus termed the xylene soluble fraction (XS %). In determining XS %, the polymer is dissolved in boiling xylene and then the solution cooled to 0° C. that results in the precipitation of the isotactic or crystalline portion of the polymer. The XS % is that portion of the original amount that remained soluble in the cold xylene. Consequently, the XS % in the polymer is indicative of the extent of crystalline polymer formed. The total amount of polymer (100%) is the sum of the xylene soluble fraction and the xylene insoluble fraction, as determined in accordance with ASTM D5492-98. In an embodiment, the HCPP has a xylene soluble fraction of less than 1.5%, or less than 1.0%, or less than 0.5%.

In an embodiment, a HCPP suitable for use in this disclosure may have any combination of the following properties. For example, the HCPP may have a density of from 0.895 g/cc to 0.920 g/cc, alternatively from 0.900 g/cc to 0.915 g/cc, and alternatively from 0.905 g/cc to 0.915 g/cc as determined in accordance with ASTM D1505; a melt flow rate of from 0.5 g/10 min. to 30 g/10 min., alternatively from 1.0 g/10 min. to 15 g/10 min., and alternatively from 1.5 g/10 min. to 5.0 g/10 min. as determined in accordance with ASTM D1238; a secant modulus in the machine direction (MD) of from 350,000 psi to 420,000 psi; alternatively from 380,000 psi to 420,000 psi, and alternatively from 400,000 psi to 420,000 psi as determined in accordance with ASTM D882; a secant modulus, in the transverse direction (TD) of from 400,000 psi to 700,000 psi, alternatively from 500,000 psi to 700,000 psi, and alternatively from 600,000 psi to 700,000 psi as determined in accordance with ASTM D882; a tensile strength at break in the MD of from 19,000 psi to 28,000 psi, alternatively from 22,000 psi to 28,000 psi, and alternatively from 25,000 psi to 28,000 psi as determined in accordance with ASTM D882; a tensile strength at break in the TD of from 20,000 psi to 40,000 psi, alternatively from 30,000 psi to 40,000 psi, and alternatively of from 35,000 psi to 40,000 psi as determined in accordance with ASTM D882; an elongation at break in the MD from 50% to 200%, alternatively from 100% to 180%, and alternatively from 120% to 150% as determined in accordance with ASTM D882; an elongation at break in the TD of from 50% to 150%, alternatively from 60% to 100%, and alternatively from 80% to 100% as determined in accordance with ASTM D882; a melting temperature of from 150° C. to 170° C., alternatively from 155° C. to 170° C., and alternatively from 160° C. to 170° C. as determined differential scanning calorimetry; a gloss at 45° of from 70 to 95, alternatively from 75 to 90, and alternatively from 80 to 90 as determined in accordance with ASTM D2457; a percentage haze of from 0.5% to 2.0%, alternatively from 0.5% to 1.5%, and alternatively from 0.5% to 1.0% as determined in accordance with ASTM D1003; and a water vapor transmission rate of from 0.15 to 0.30 g-mil/100 in2/day, alternatively from 0.15 to 0.25 g-mil/100 in2/day, and alternatively from 0.20 to 0.21 g-mil/100 in2/day as determined in accordance with ASTM F1249-90.

In another embodiment, the polypropylene may be a polypropylene heterophasic copolymer (PPHC) wherein a polypropylene homopolymer phase or component is joined to a copolymer phase or component. The PPHC may comprise from greater than 6.5% to less than 11.5% by weight ethylene, alternatively from 8.5% to less than 10.5%, alternatively from 9.5% ethylene based on the total weight of the PPHC. Herein, percentages of a component refer to the percent by weight of that component in the total composition unless otherwise noted.

The copolymer phase of a PPHC may be a random copolymer of propylene and ethylene, also referred to as an ethylene/propylene rubber (EPR). In an embodiment, the EPR portion of the PPHC comprises greater than 14 wt. % of the PPHC, alternatively greater than 18 wt. % of the PPHC, alternatively from 1.4 wt. % to 18 wt. % of the PPHC.

The amount of ethylene present in the EPR portion of the PPHC may be from 38 wt. % to 50 wt. %, alternatively from 40 wt. % to 45 wt. % based on the total weight of the EPR portion. The amount of ethylene present in the EPR portion of the PPHC may be determined spectrophotometrically using a Fourier transform infrared spectroscopy (FTIR) method. Specifically, the FTIR spectrum of a polymeric sample is recorded for a series of samples having a known EPR ethylene content. The ratio of transmittance at 720 cm-1/900 cm-1 is calculated for each ethylene concentration and a calibration curve may then be constructed. Linear regression analysis on the calibration curve can then be carried out to derive an equation that is then used to determine the EPR ethylene content for a sample material.

The EPR portion of the PPHC may exhibit an intrinsic viscosity different from that of the propylene homopolymer component. Herein intrinsic viscosity refers to the capability of a polymer in solution to increase the viscosity of said solution. Viscosity is defined herein as the resistance to flow due to internal friction. In an embodiment, the intrinsic viscosity of the EPR portion of the PPHC may be greater than 2.0 dl/g, alternatively from 2.0 dl/g to 10 dl/g, alternatively from 2.4 dl/g to 3.0 dl/g, alternatively, from 2.4 dl/g to 2.7 dl/g, alternatively from 2.6 dl/g to 2.8 dl/g. The intrinsic viscosity of the EPR portion of the PPHC is determined in accordance with ASTM D5225.

In an embodiment, the PPHC may have a melt flow rate (MFR) of from 65 g/10 min. to 13.0 g/10 min., alternatively from 70 g/10 min. to 120 g/10 min., alternatively from 70 g/10 min. to 100 g/10 min., alternatively from 70 g/10 min. to 90 g/10 min., alternatively from 75 g/10 min. to 85 g/10 min., alternatively 90 g/10 min. Excellent flow properties as indicated by a high MFR allow for high throughput manufacturing of molded polymeric components. In an embodiment, the PPHC is a reactor grade resin without modification, which may also be termed a low order PP. In some embodiments, the PPHC is a controlled rheology grade resin, wherein the melt flow rate has been adjusted by various techniques such as visbreaking. For example, MFR may be increased by visbreaking as described in U.S. Pat. No. 6,503,990, which is incorporated by reference in its entirety. As described in that publication, quantities of peroxide are mixed with polymer resin in flake, powder, or pellet form to increase the MFR of the resin. MFR as defined herein refers to the quantity of a melted polymer resin that will flow through an orifice at a specified temperature and under a specified load. The MFR may be determined using a dead-weight piston Plastometer that extrudes polypropylene through an orifice of specified dimensions at a temperature of 230° C. and a load of 2.16 kg in accordance with ASTM D1238.

The lactide may include any lactide known in the art, such as L-lactide, D-lactide or D, L-lactides (a cyclic dimer produced from the dehydration of lactic acid with a melting point of 123° C.), for example.

Polylactic acid may be formed by contacting a lactide with a catalyst. Such catalysts are known in the art and may include catalysts, such as tin compounds (e.g., tin octylate), titanium compounds (e.g., tetraisopropyl titanate), zirconium compounds (e.g., zirconium isopropoxide), antimony compounds (e.g., antimony trioxide), metal oxides or combinations thereof, for example. Below is depicted a catalytic ring-opening polymerization of lactide (left), which is a cyclic lactic acid oligomer, to polylactide (right) or polylactic acid.

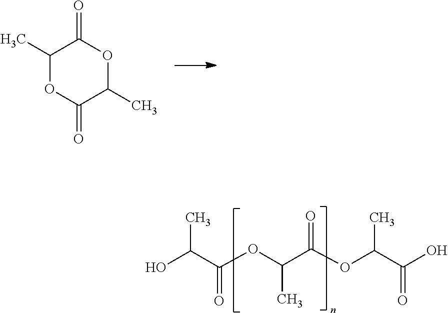

Embodiments described herein produce PO/PLA polymeric blends in situ by catalyzing lactides such that they polymerize via ring-opening into PLA in PO melts during reactive extrusion in situ within an extruder.

The polymeric blends may be prepared by contacting a lactide and polyolefin (reaction mixture) in the presence of a catalyst to form the polymeric blend. Such contact may occur molten state inside of a batch mixer, single extruder, or a twin-screw extruder, for example.

The catalyst'may be introduced in an amount of from about 0.01 wt. % to about 2 wt. % or from about 0.2 wt. % to about 0.8 wt. % or from about 0.3 wt. % to about 0.5 wt. % based on the total weight of the reaction mixture, for example.

This process may take from minutes, such as about 5 minutes, to several hours of polymerization time, for example, at temperatures of from 180° C. to 210° C.

In an embodiment, formed polylactic acid is present in the polymeric blend in an amount of from 1 wt. % to 49 wt. % by total weight of the polymeric blend, alternatively from 5 wt. % to 30 wt. %, alternatively from 10 wt. % to 20 wt. %. In one or more embodiments, the polymeric blend prepared by contacting a lactide and polyolefin (reaction mixture) in the presence of a catalyst can be further mixed with a reactive modifier. As used herein, the term “reactive modifier” refers to polymeric additives that, when added to a molten blend of immiscible polymers (e.g., the olefin based polymer and the lactide), form compounds in situ that serve to stabilize the blend. The compounds formed in situ compatibilize the blend and the reactive modifiers are precursors to these compatibilizers.

In one or more embodiments, the reactive modifier includes an epoxy-functionalized polyolefin. Examples of epoxy-functionalized polyolefins include epoxy-functionalized polypropylene, such as glycidyl methacrylate grafted polypropylene (PP-g-GMA), epoxy-functionalized polyethylene, such as polyethylene co glycidyl methacrylate (PE-co-GMA) and combinations thereof, for example. An example of an epoxy-functionalized polyethylene suitable for use in this disclosure includes LOTADER AX8840, which is a PE-co-GMA containing 8% GMA that is commercially available from Arkema.

In one or more embodiments, the reactive modifier is selected from oxazoline-grafted polyolefins, maleated polyolefin-based ionomers, isocyanate (NCO)-functionalized polyolefins and combinations thereof, for example. The oxazoline-grafted polyolefin is a polyolefin grafted with an oxazoline ring-containing monomer. In one or more embodiments, the oxazoline may include a 2-oxazoline, such as 2-vinyl-2-oxazoline (e.g., 2-isopropenyl-2-oxazoline), 2-fatty-alkyl-2-oxazoline (e.g., those obtainable from the ethanolamide of oleic acid, linoleic acid, palmitoleic acid, gadoleic acid, erucic acid and/or arachidonic acid) and combinations thereof, for example. In yet another embodiment, the oxazoline may be selected from ricinoloxazoline maleinate, undecyl-2-oxazoline, soya-2-oxazoline, ricinus-2-oxazoline and combinations thereof, for example. In yet another embodiment, the oxazoline is selected from 2-isopropenyl-2-oxazoline, 2-isopropenyl-4,4-dimethyl-2-oxazoline and combinations thereof, for example. The oxazoline-grafted polyolefin may include from about 0.1 wt. % to about 10 wt. % or from 0.2 wt. % to about 2 wt. % oxazoline, for example.

The isocyanate (NCO)-functionalized polyolefins include a polyolefin grafted with an isocyanate functional monomer. The isocyanate may be selected from TMI® unsaturated isocyanate (meta), meta and para-isopropenyl-alpha, alpha-dimethylbenzyl isocyanate; meta-isopropenyl-alpha, alpha-dimethylbenzyl isocyanate; para-isopropenyl-alpha, alpha-dimethylbenzyl isocyanate and combinations thereof, for example.

The maleated polyolefin-based ionomers include a polyolefin ionomer maleated and then neutralized with a metal component. Maleation is a type of grafting wherein maleic anhydride, acrylic acid derivatives or combinations thereof are grafted onto the backbone chain of a polymer. The metal component may be selected from sodium hydroxide, calcium oxide, sodium carbonate, sodium hydrogencarbonate, sodium methoxide, sodium acetate, magnesium ethoxide, zinc acetate, diethylzine, aluminium butoxide, zirconium butoxide and combinations thereof, for example. In one specific embodiment, the metal component is selected from sodium hydroxide, zinc acetate and combinations thereof, for example.

In one or more embodiments, the graftable polymer is a polyolefin that is selected from polypropylene, polyethylene, combinations thereof and copolymers thereof.

The reactive modifiers may be prepared by any suitable method. For example, the reactive modifiers may be formed by a grafting reaction. The grafting reaction may occur in a molten state inside of a batch mixer, single extruder, or a twin-screw extruder, for example (e.g., “reactive extrusion”).

In one or more embodiments, the reactive modifiers are formed by grafting in the presence of an initiator, such as peroxide. Examples of initiators may include LUPERSOL® 101 and TRIGANOX® 301, commercially available from Arkema, Inc., for example.

The initiator may be used in an amount of from about 0.01 wt. % to about 2 wt. % or from about 0.2 wt. % to about 0.8 wt. % or from about 0.3 wt. % to about 0.5 wt. % based on the total weight of the reactive modifier, for example.

Alternatively, the reactive modifiers may be formed by grafting, in the presence of an initiator, such as those described above, and a modifier selected from multi-functional acrylate comonomers, styrene, triacrylate esters and combinations thereof, for example. The multi-functional acrylate comonomer may be selected from polyethylene glycol diacrylate, trimethylolpropane triacrylate (TMPTA), alkoxylated hexanediol diacrylatete and combinations thereof, for example. The triacrylate esters may include trimethylopropane triacrylate esters, for example. It has unexpectedly been observed that the modifiers described herein are capable of improving grafting compared to processes absent such comonomers.

The multi-functional acrylate comonomer may be further characterized by a high flash point. The flash point of a material is the lowest temperature at which it can form an ignitable mixture in air, as determined in accordance with ASTM D93. The higher the flash point, the less flammable the material, which is a beneficial attribute for melt reactive extrusion. In an embodiment, the multi-functional acrylate comonomer may have a flash point of from 50° C. to 120° C. alternatively of from 70° C. to 100° C., alternatively of from 80° C. to 100° C. Examples of multi-functional acrylate comonomers suitable for use in this disclosure include without limitation SR256 (polyethylene glycol diacrylate), CD560 (alkoxylated hexanediol diacrylate), and SR351 (TMPTA), which are commercially available from Sartomer.

In one or more embodiments, the reactive modifier may include from about 80 wt. % to about 99.5 wt. %, or from about 90 wt. % to about 99 wt. % or from about 95 wt. % to about 99 wt. % polyolefin based on the total weight of the reactive modifier, for example.

In one or more embodiments, the reactive modifier may include from about 0.5 wt. % to about 20 wt. %, or from about 1 wt. % to about 10 wt. % or from about 1 wt. % to about 5 wt. % grafting component (i.e., the oxazoline, isocyanate, maleic anhydride, acrylic acid derivative) based on the total weight of the reactive modifier, for example.

In one or more embodiments, the reactive modifier may include from about 0.5 wt. % to about 15 wt. %, or from about 1 wt. % to about 10 wt. % or from about 1 wt. % to about 5 wt. % modifier on the total weight of the reactive modifier, for example.

The ratio of grafting component to modifier may vary from about 1:5 to about 10:1, or from about 1:2 to about 5:1 or from about 1:1 to about 3:1, for example.

In one or more embodiments, the reactive modifier may exhibit a grafting yield of from about 0.2 wt. % to about 20 wt. %, or from about 0.5 wt. % to about 10 wt. % or from about 1 wt. % to about 5 wt. %, for example. The grafting yield may be determined by Fourier Transform Infrared Spectroscopy (FTIR) spectroscopy.

In an embodiment, a method for determining the grafting yield comprises obtaining the FTIR spectra of polymeric samples having a mixture of PP and GMA wherein the amount of each component is known. A calibration curve may be generated by plotting the signal intensity at one or more wavelengths as a function of component concentration. The FTIR spectra of a PP-g-GMA sample may then be determined and compared to the calibration curve in order to determine the grafting yield. This method is described in more detail in Angew. Makromol. Chem, 1995, V229 pages 1-13 which is incorporated by reference herein in its entirety.

The polymeric composition may include froth about 0.5 wt. % to about 20 wt. %, or from about 1 wt. % to about 10 wt. % or from about 3 wt. % to about 5 wt. % reactive modifier based on the total weight of the polymeric composition, for example.

In an embodiment, the polymeric composition may contain additives to impart desired physical properties, such as printability, increased gloss, or a reduced blocking tendency. Examples of additives may include, without limitation, stabilizers, ultra-violet screening agents, oxidants, anti-oxidants, anti-static agents, ultraviolet light absorbents, fire retardants, processing oils, mold release agents, coloring agents, pigments/dyes, fillers or combinations thereof, for example. These additives may be included in amounts effective to impart desired properties.

The polymeric composition may exhibit a melt flow rate of from about 0.5 g/10 min. to about 500 g/10 min., or from about 1.5 g/10 min. to about 50 g/10 min. or from about 5.0 g/10 min. to about 20 g/10 min, for example. (MFR as defined herein refers to the quantity of a melted polymer resin that will flow through an, orifice at a specified temperature and under a specified load. The MFR may be determined using a dead-weight piston Plastometer that extrudes polypropylene through an orifice of specified dimensions at a temperature of 230° C. and a load of 2.16 kg in accordance with ASTM D1238.)

The polymeric compositions are useful in applications known to one skilled in the art to be useful for conventional polymeric compositions, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

While the foregoing is directed to embodiments of the present invention, other and further embodiments of the invention may be devised without departing from the basic scope thereof and the scope thereof is determined by the claims that follow.

What is claimed is:

1. A method of forming a polymeric composition comprising:
contacting a polyolefin and a lactide in the presence of a catalyst within an extruder under conditions sufficient to polymerize the lactide and form a polymeric composition comprising polyolefin and polylactic acid.

2. The method of claim 1, wherein the polyolefin is selected from polyethylene, polypropylene and combinations thereof.

4. The method of claim 1, wherein the lactide is selected from D-lactide, L-lactide, or D,L-Lactide and combinations thereof.

5. The method of claim 1, wherein the catalyst is selected from octoate (tin(II)-di-2-ethyl hexanoate), tin octylate, tetraisopropyl titanate, zirconium isopropoxide, antimony trioxide and combinations thereof.

6. The method of claim 1, wherein the polymeric composition comprises polyolefin in an amount of from about 51 wt. % to about 99 wt. % based on the total weight of the composition.

7. The method of claim 1, wherein the polymeric composition comprises polylactic acid in an amount of from about 1 wt. % to about 49 wt. % based on the total weight of the composition.

8. The method of claim 1, wherein the catalyst contacts the polyolefin and lactide in an amount of from about 0.0.1 wt. % to about 2 wt. %.

9. The method of claim 1, wherein the catalyst contacts the polyolefin and lactide at a temperature of from about 180° C. to about 210° C.

10. The method of claim 1, wherein the catalyst contacts the polyolefin and lactide for a time of from about 5 minutes to about 3 hours.

11. The method of claim 1 further comprising contacting the polymeric composition with a reactive modifier.

12. The method of claim 11, wherein the reactive modifier is selected from an epoxy-functionalized polyolefin, oxazoline-functionalized polyolefins, isocyanate-functionalized polyoefins, and polyolefin-based ionomers.

13. A polymeric composition formed by the method of claim 1.

14. The composition of claim 13 further comprising a reactive modifier.

15. The composition of claim 14, wherein the reactive modifier comprises an epoxy-functionalized polyolefin, oxazoline-functionalized polyolefins, isocyanate-functionalized polyoefins, and polyolefin-based ionomers.

16. The composition of claim 13, wherein the polyolefin is selected from polyethylene, polypropylene and combinations thereof.

17. The composition of claim 13, wherein the polymeric composition comprises polyolefin in an amount of from about 51 wt. % to about 99 wt. % based on the total weight of the composition.

18. The composition of claim 13, wherein the polymeric composition comprises polylactic acid in an amount of from about 1 wt. % to about 49 wt. % based on the total weight of the composition.

19. A method of forming a polymeric composition comprising:
contacting polypropylene and a lactide in the presence of a catalyst and a reactive modifier within an extruder under conditions sufficient to polymerize the lactide and form a polymeric composition comprising polypropylene and polylactic acid, wherein the catalyst is selected from octoate (tin(II)-di-2-ethyl hexanoate), tin octylate, tetraisopropyl titanate, zirconium isopropoxide, antimony trioxide and combinations thereof, wherein the polymeric composition comprises polypropylene in an amount of from about 51 wt. % to about 99 wt. % based on the total weight of the composition and wherein the reactive modifier is selected from an epoxy-functionalized polyolefin, oxazoline-functionalized polyolefins, isocyanate-functionalized polyoefins, and polyolefin-based ionomers.

20. The method of claim 19, wherein the lactide is selected from D-lactide, L-lactide, or D,L-Lactide and combinations thereof.
